(19) United States
(12) Patent Application Publication
(10) Pub. No.: US 2025/0258748 A1
(43) Pub. Date: Aug. 14, 2025

(54) VISUALIZATION OF CLUSTERS TO SUPPORT SOFTWARE ASSET MANAGEMENT

(71) Applicant: ServiceNow, Inc., Santa Clara, CA (US)

(72) Inventors: Srinivas Ramanujaiah, Amsterdam (NL); Prasoon Awasthi, Hyderabad (IN); Tarun Kedia, Hyderabad (IN); Sumit Verma, Indore (IN)

(21) Appl. No.: 18/436,816

(22) Filed: Feb. 8, 2024

(51) Int. Cl. G06F 11/32; G06F 9/50

(52) U.S. Cl. CPC G06F 11/324; G06F 9/5027

(57) ABSTRACT

In various embodiments, a process for visualizing clusters to support software asset management (SAM) includes obtaining information regarding computing infrastructure resource utilizations of hosts of a specific cluster, and identifying software license utilizations of the hosts of the specific cluster. The process provides, via a user interface, a first visual user interface element indicating an aggregation of the computing infrastructure resource utilizations of the specific cluster, and a second visual user interface element indicating an aggregation of the identified software license utilizations of the specific cluster

### BACKGROUND OF THE INVENTION

A computing cluster refers to a group of components including one or more of the following: a host such as a hardware device, a hypervisor that manages the members of the group, and software such as a virtual machine. Clusters are being increasingly used for computing because they provide flexibility for various applications via load balancing. For example, clusters enable the efficient allocation of resources to reduce under-utilization and over-utilization. Clusters may be used to facilitate software asset management, such as licensing, which may be shared across cluster components. However, it is cumbersome for an administrator to view the structure of a cluster and understand licensing compliance associated with the cluster.

### BRIEF DESCRIPTION OF THE DRAWINGS

Various embodiments of the invention are disclosed in the following detailed description and the accompanying drawings.

FIG. 1 is a flow diagram illustrating an embodiment of a process for visualization of clusters to support software asset management.

FIG. 2 is a block diagram illustrating a network environment for visualization of clusters to support software asset management.

FIG. 3 shows an example of a cluster within a customer network environment.

FIG. 4 shows an example of a user interface for selecting a cluster to visualize the selected cluster to support software asset management obtained in some embodiments.

FIG. 5 shows an example of a user interface for visualizing a cluster to support software asset management obtained in some embodiments.

FIG. 6 shows an example of a user interface for visualizing a cluster to support software asset management including host information obtained in some embodiments.

FIG. 7 shows an example of a user interface for visualizing a cluster to support software asset management including virtual machine information obtained in some embodiments.

FIG. 8 shows an example of a user interface for visualizing a cluster to support software asset management including software installation information obtained in some embodiments.

FIG. 9 shows an example of a user interface for visualizing a cluster to support software asset management including licensing information obtained in some embodiments.

FIG. 10 is a functional diagram illustrating a programmed computer system for visualization of clusters to support software asset management in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, “cluster” refers to a group of hosts configured to share resources. For example, the resources include virtual machines and software. A particular virtual machine may have software installed. A “host” refers to a physical machine. A physical machine may include one or more processors and each processor may have one or more smaller processing units called physical cores and/or hyper-threads. A particular cluster or components within the cluster such as virtual machines can be provided by an entity such as a third party service. Software is typically used with a license, which defines the terms of usage. Various licensing models exist. For example, a license may be assigned to a particular device or user, permitting that device or user to run software on a server. In one example, a license may be for a particular host and permit a defined number of VMs running on the host to use the software. In another example, a license may be per core where the number of core licenses equals the number of physical cores on a license server. In yet another example, a license may be shared among the virtual machines. For example, a license that permits five instances of software may be shared among five virtual machines that each has one instance installed. In many scenarios, a license might not be used to its maximum capacity. Examples of licenses include but are not limited to:
hypervisor licenses,
management server licenses,
managed server licenses,
guest operating server licenses,
guest operating server client access licenses,
application (or software installation) licenses,
application (or software installation) client access licenses.

Software asset management (SAM) refers to processes that manage and optimize the acquisition, deployment, maintenance, utilization, and disposal of software applications within an organization. SAM technologies may be used to manage and visualize infrastructure, licensing usage, and optimizations related to both infrastructure and licensing usage according to the disclosed techniques. SAM technologies track license expiration and usage, which is helpful for an organization to ensure that they are efficiently using licenses, complying with licensing agreements, and minimizing risk. SAM helps in maintaining an accurate and up-to-date inventory of software assets within an organization. This includes information about installed software, license entitlements, and usage data. SAM assists in managing software licenses, tracking entitlements, and ensuring compliance with software vendor agreements. This helps organizations avoid over-licensing or under-licensing situations. SAM enables organizations to monitor software license compliance against purchased licenses, ensuring that they are in compliance with vendor terms and avoiding legal and financial risks associated with non-compliance. SAM helps organizations optimize their software spending by identifying unused or underutilized software licenses, recommending cost-saving measures, and providing insights into software consumption patterns. SAM facilitates effective communication and collaboration with software vendors. It helps organizations stay informed about software license changes, updates, and negotiations. SAM assists in identifying and mitigating risks associated with software asset management, such as security vulnerabilities, non-compliance issues, and potential legal implications. SAM provides reporting and analytics capabilities to generate insights into software usage, compliance status, and cost optimization opportunities.

Techniques for visualization of clusters to support software asset management are disclosed. In various embodiments, a user interface for cluster visualization displays a structure of a cluster along with information about the cluster such as infrastructure, software asset usage (e.g., licensing) compliance, optimization, and health issues. The information for the user interface is obtained through discovery, reconciliation, or the like. In various embodiments, a process for generating the user interface includes discovering computing infrastructure resource utilizations of hosts of a specific cluster and identifying software license utilizations of the hosts. The discovery of the resource utilizations and license utilizations may be performed automatically and obtained by using appropriate tables to look up the information. For example, the information may be readily available from earlier processes. A user interface is rendered. For example, a first visual user interface element indicates an aggregation of the computing infrastructure resource utilizations of the specific cluster, and a second visual user interface element indicates an aggregation of the identified software license utilizations of the specific cluster.

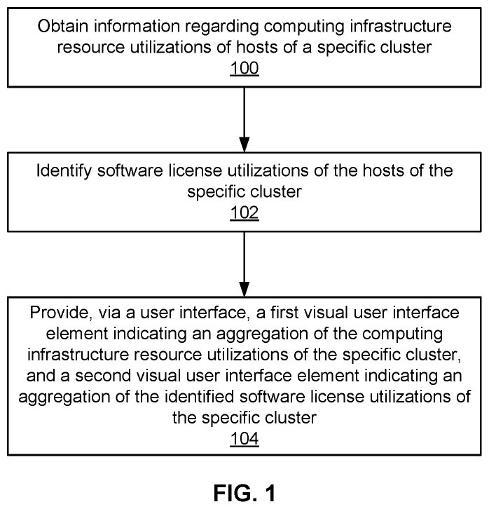

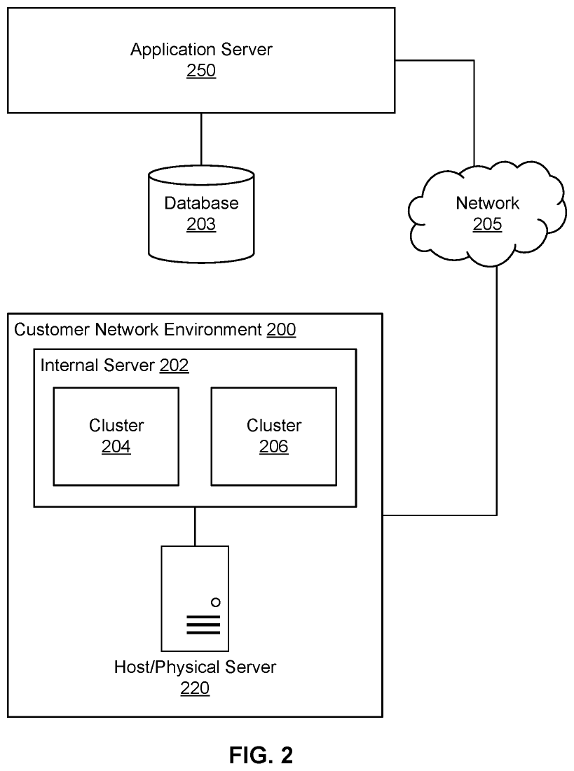

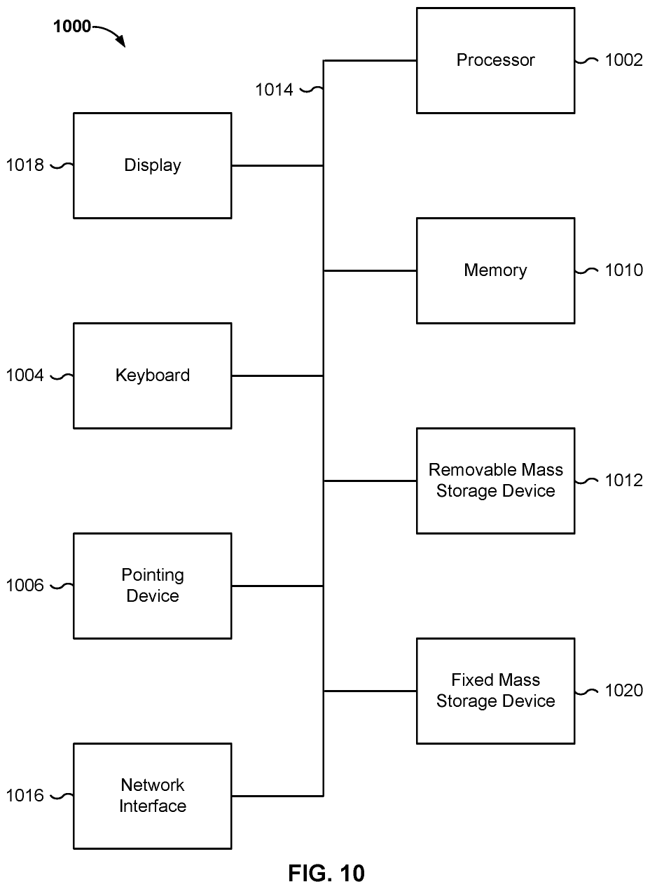

FIG. 1 is a flow diagram illustrating an embodiment of a process for visualization of clusters to support software asset management. This process may be implemented on or by a processor such as application server 250 of FIG. 2 or processor 1002 of FIG. 10.

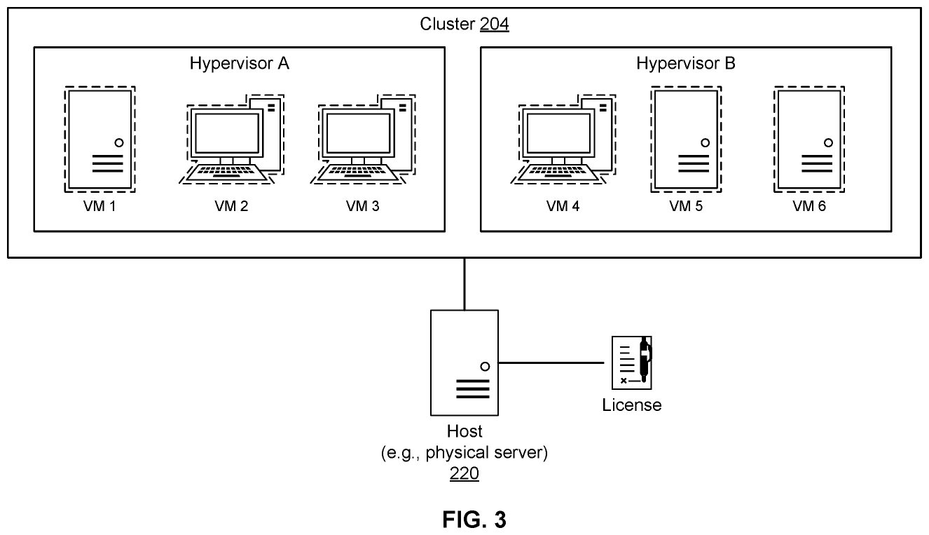

In the example shown, the process begins by obtaining information regarding computing infrastructure resource utilizations of hosts of a specific cluster (100). As described herein, a particular cluster may have one or more associated hosts or physical servers. A particular host may be associated with (e.g., host) one or more virtual machines (VMs), and VMs can move across hosts. Thus, a cluster is a virtualization mechanism in which there are different physical hosts and virtual machines that can run via the different physical hosts. An example of a cluster is further described with respect to FIGS. 2 and 3.

In order to support the VMs, the host may consume various levels of resources. The computing infrastructure resource utilization of a host refers to a host's consumption of resources to perform its functions. Because VMs can move between different physical hosts (or more generally, virtualization offers flexible set-ups in which components are easily re-configured), it may be difficult to track whether an organization remains in compliance with the rules and conditions stipulated by a license agreement. For example, a license may authorize a particular software instance to be installed on a particular host and used by three users (virtual machines). When a fourth VM is added, the license rules will be violated.

A manager may view the infrastructure and licensing compliance of a particular cluster by initiating the process described here. The information regarding computing infrastructure resource utilizations of the hosts of the specific cluster may be obtained by performing a discovery process with respect to the hosts of the specific cluster as further described herein with respect to FIG. 2. Discovery refers to a process that maps or otherwise determines the structure/infrastructure of a cluster. Discovery provides a point-in-time snapshot of a cluster. The information obtained during discovery may be stored across one or more tables. For example, one table stores hypervisor information, another table stores VM information, yet another table stores host information, etc.

Conventional techniques lack a way to display the information about a cluster in a user-friendly way. For example, a user first views a host information in a first table, and then goes to look up other tables to discover further information about the host. The disclosed techniques present information about a cluster's infrastructure and licensing (among others) in a unified view, enabling decision makers to easily analyze and make decisions about the cluster.

The process identifies software license utilizations of the hosts of the specific cluster (102). The identification of the software license utilizations of the hosts of the specific cluster includes an identification of a software license of the software license utilizations and a corresponding location where the software license is utilized. The location may include but is not limited to a physical location, host, device, software instance, or virtual machine instance. Examples of software licensing models are further described herein, and the location where the software license is utilized may correspond to permitted licensing locations.

The process provides, via a user interface, a first visual user interface element indicating an aggregation of the computing infrastructure resource utilizations of the specific cluster, and a second visual user interface element indicating an aggregation of the identified software license utilizations of the specific cluster (104). The first visual user interface element and the second visual user interface element may be present in a unified user interface, providing easy access for a user such as a SAM manager.

FIG. 2 is a block diagram illustrating a network environment for visualization of clusters to support software asset management. In the example shown, application server 250 and customer network environment 200 are connected via network 205. Network 205 can be a public or private network. In some embodiments, network 205 is a public network such as the Internet. In various embodiments, application server 250 is a cloud-based application server that provides application services including an information technology operations management (ITOM) cloud service to determine metrics including resource expenditures of a digital service (sometimes simply referred to as “services”) running within a customer network such as customer network environment 200. Application server 250 utilizes database 203, which is communicatively connected to application server 250. Application server 250 together with internal server 202, which is located within customer network environment 200, are part of a platform for discovering the infrastructure of customer network environment 200. For example, using discovery service offered by application server 250, an administrator is presented with the discovered services running within customer network environment 200 that utilize one or more of the devices of customer network environment 200 along with a visualization of clusters to support SAM. In the example shown, example devices of customer network environment 250 are the internal server 202 and the physical server 220.

In some embodiments, database 203 is utilized by application server 250 for determining a visualization of a cluster as further described herein. One or more clusters 204 and 206 may be associated with internal server 202. For example, database 203 can be used to store discovery data associated with services discovered within a customer network such as customer network environment 200. The database 203 may store license information associated with the customer network environment 200. The database 203 may store host affinity rules. In some embodiments, database 203 is implemented using one or more databases such as one or more distributed database servers. For example, although shown as a single entity in FIG. 2, database 203 can be implemented as one or more distributed database components connected via network 205 to application server 250.

In some embodiments, database 203 further functions as a CMDB and is used at least in part for managing assets that are under the management of an organization, such as internal server 202 and physical server 220 of customer network environment 200. For example, each managed asset can be represented as a configuration item (CI) within database 203. In some embodiments, database 203 stores information related to managed assets, such as the hardware and/or software configuration of a computing device, as configuration items.

In some embodiments, application server 250 provides cloud-based services for managing information technology operations including determining metrics of a service within a customer's information technology environment. For example, a service running on the customer's network environment can utilize entities (or devices) within the customer's network infrastructure. The connections between processes running on these devices are discovered and used to discover the associated services running within customer network environment 200. Once a service is discovered and associated metrics such as license usage are determined, the discovered services and associated metrics are provided to the customer via a visualization user interface offered by application server 250. The cloud-based discovery service can present the metrics within or alongside visual maps and allow an administrator the ability to make adjustments to and decisions about the services based on the metrics. For example, the administrator may change the assignment of licenses to devices, change the type of device or resource utilized (downsize the database or storage used), or the like. In some embodiments, application server 250 offers additional cloud services such as a configuration management database (CMDB) service for managing devices and/or configuration items for a customer. In various embodiments, application server 250 stores collected discovery service data and determines optimizations related to license utilization in database 203.

In some embodiments, customer network environment 200 is an information technology network environment and includes multiple hardware devices including physical server 220, as an example. Device 220 corresponds to a hardware device and can be one of a variety of different hardware device types including networking equipment (such as gateways and firewalls), load balancers, servers including application servers and database servers among other servers, and other computing devices including employee laptops and desktops. Device 220 is configured with different hardware and software components, and they generally have the ability to accept or initiate connections between processes associated with the devices and in some instances with a network client located outside of customer network environment 200. In various embodiments, customer network environment 200 is connected to network 205. In the example shown, internal server 202, either alone or with the help of additional monitoring modules or agents, is capable of monitoring the processes and/or network connections associated with the devices within customer network environment 200, such as the processes running on device 220 and its associated network connections. In various embodiments, the topology of customer network environment 200 can differ and the topology shown in FIG. 2 is just one simplified example.

In the example shown, internal server 202 is an intranet server of customer network environment 200 and the bi-directional connections between internal server 202 and device 220 represent the ability for internal server 202 to monitor device 220. Depending on the network configuration, the components within customer network environment 200 including internal server 202 and device 220 may have full or limited bi-directional or one-directional network connectivity to one another. Internal server 202 can be configured to receive and perform service discovery requests from application server 250 including requests to monitor the processes running and/or connections established within customer network environment 200. The results of the monitoring are sent back to application server 250 where they can be analyzed and evaluated to identify discovered services and determine metrics associated with the discovered services. Although other approaches may be appropriate, in various embodiments, internal server 202 is utilized to perform the monitoring because it resides within customer network environment 200 and has increased access privileges to devices and network data communication that a device outside of customer network environment 200 does not have. For example, internal server 202 can be configured with access permissions allowing it to monitor the data connections between processes running on the devices within customer network environment 200 as well as the ability to monitor what processes are running on the respective devices. In some embodiments, internal server 202 may rely on one or more monitoring agents and/or monitoring components associated with the different devices and/or potential sub-networks (not shown) of customer network environment 200, for example, to properly monitor the data communication and information used for determining metrics of services.

In some embodiments, the functionality of internal server 202 may be implemented by one or more additional devices including by customer devices. For example, monitoring agents can be installed on or in parallel to the respective devices to monitor processes and/or network connections associated with different devices. Depending on the network configuration of customer network environment 200, such as the ability to accept certain types of incoming network connections, at least a portion of the functionality performed at internal server 202 can be implemented by application server 250.

Although single instances of some components have been shown to simplify the diagram of FIG. 2, additional instances of any of the components shown in FIG. 2 may exist. For example, application server 250 and database 203 may include one or more servers and/or may share servers. In some embodiments, database 203 may not be directly connected to application server 250. For example, database 203 and its components may be replicated and/or distributed across multiple servers and/or components. In some embodiments, components not shown in FIG. 2 may also exist. For example, network clients used to access application server 250 are not shown.

FIG. 3 shows an example of a cluster within a customer network environment. In this example, cluster 204 has an underlying host 220. That is, a physical server 220 hosts the cluster 204. The cluster includes a first hypervisor (Hypervisor A) and a second hypervisor (Hypervisor B). Each hypervisor has three VMs as indicated. In this exemplary licensing scheme, the host is assigned a license (License A). This license may have a term such as being used for up to 10 VMs. Licensing for this may be optimized using the disclosed techniques.

For example, suppose physical server installations may be categorized as “standard” or “datacenter.” Suppose that the “standard” edition is licensed for two operating system environments (OSEs) or hypervisors. Additional OSEs require additional licenses. The “datacenter” edition is licensed for unlimited OSEs. Both types of installations are licensed on a per physical core basis. The licenses are available in packs of two or packs of 16. Suppose the minimum requirements for physical server clustering are: all physical cores must be licensed, eight core licenses per processor, and 16 core licenses per server. A cluster is licensed by calculating the maximum number of VMs that can run on one physical host.

A cluster or host density is determined by dividing the active operating systems by two. A license threshold assigned by the system is computed based on a ratio of the cost of datacenter and non-datacenter licenses. The threshold can be used to identify a optimal cluster size for datacenter licenses. The threshold value can be modified or selected based on the purchase costs for the licenses. Low density clusters are licensed by non-datacenter licenses starting from low to high density. High density clusters are licensed by datacenter licenses starting from high to low density. Optimal license and potential savings are calculated for a host or cluster using non-optimal licenses.

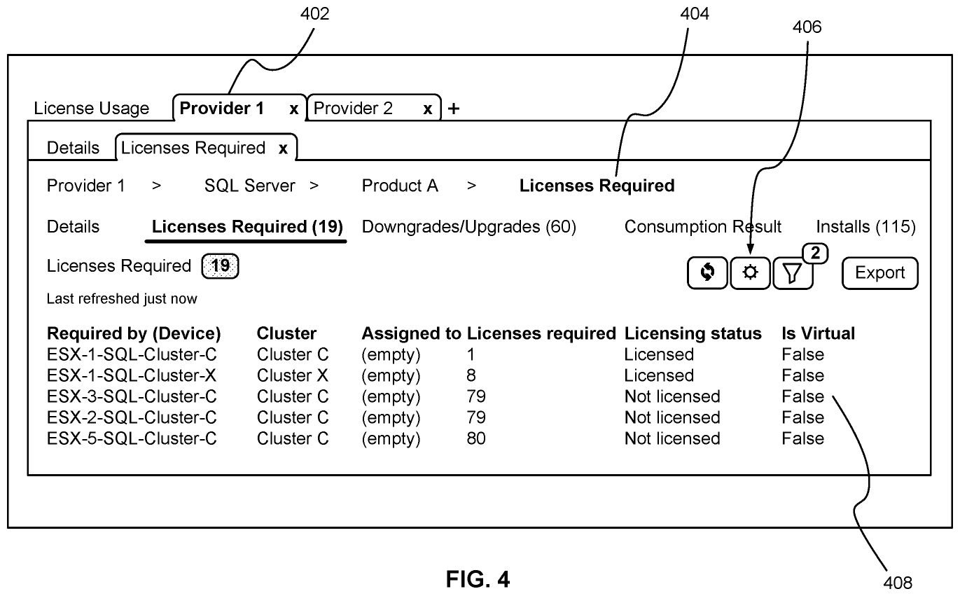

FIG. 4 shows an example of a user interface for selecting a cluster to visualize the selected cluster to support software asset management obtained in some embodiments. A user may view license usage information by provider. Here, selecting tab 402 causes information for a first provider (Provider 1) to be displayed. Navigation may be aided by a map or menu, in which the current information “Licenses Required” 404 is displayed. In this example there are 19 licenses required for Product A of Provider 1. Menu options 406 allow the information to be refreshed, filtered, exported, or otherwise altered.

A user interface for visualization of a cluster may be displayed in response to selecting 408 as shown in the following figure. In various embodiments, a user interface generated according to the disclosed techniques is a unified interface including the first visual user interface element and the second visual user interface element within a same view. The following figures show some examples of a user interface.

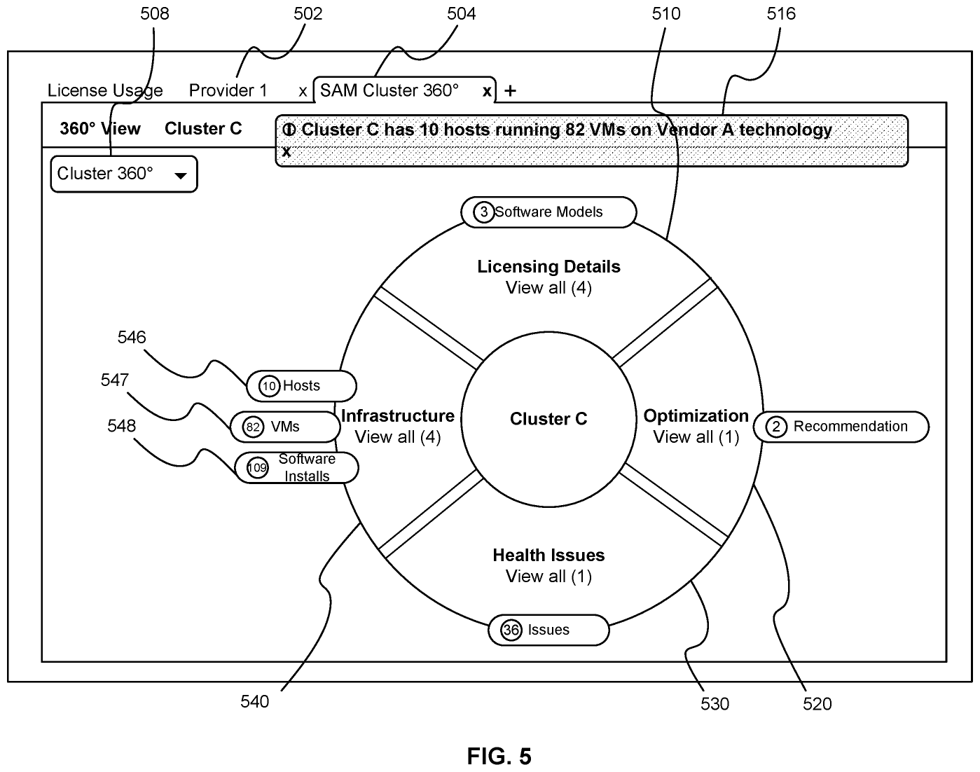

FIG. 5 shows an example of a user interface for visualizing a cluster to support software asset management obtained in some embodiments. In this example of a unified user interface, a first visual user interface element 540 and the second visual user interface element 510 are displayed within a same view. The first visual user interface element and the second visual user interface element are presented as respective wedges in a circular shape. Further visual user interface elements may be displayed. For example, a third visual user interface element 520 indicates an optimization associated with the at least one of: the computing infrastructure resource utilizations of the specific cluster or the identified software license utilizations of the specific cluster. A fourth visual user interface element 530 indicates a health issue associated with the at least one of: the computing infrastructure resource utilizations of the specific cluster, or the identified software license utilizations of the specific cluster. The four visual user interface elements are merely exemplary and not intended to be limiting. For example, different elements or additional elements may be shown depending on user preference.

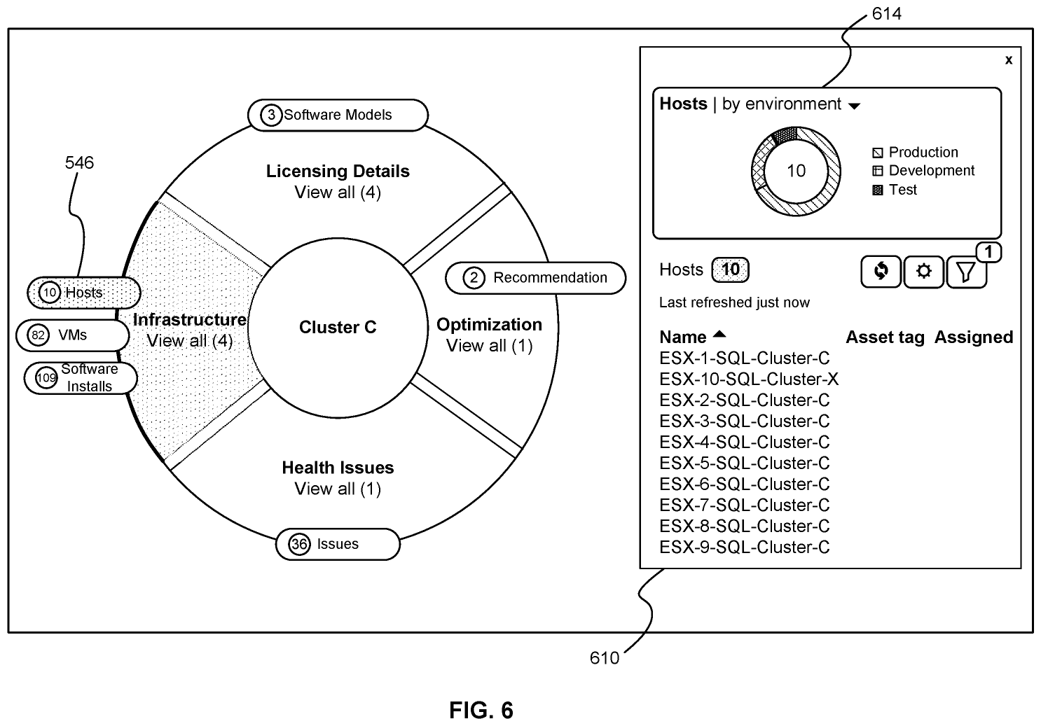

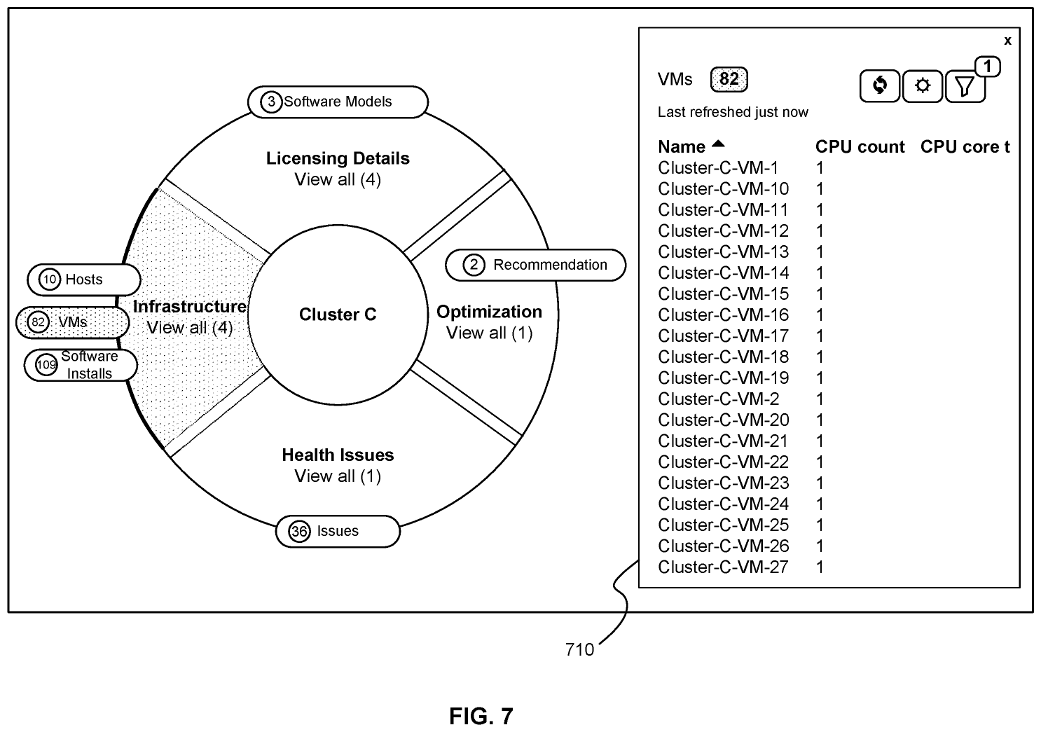

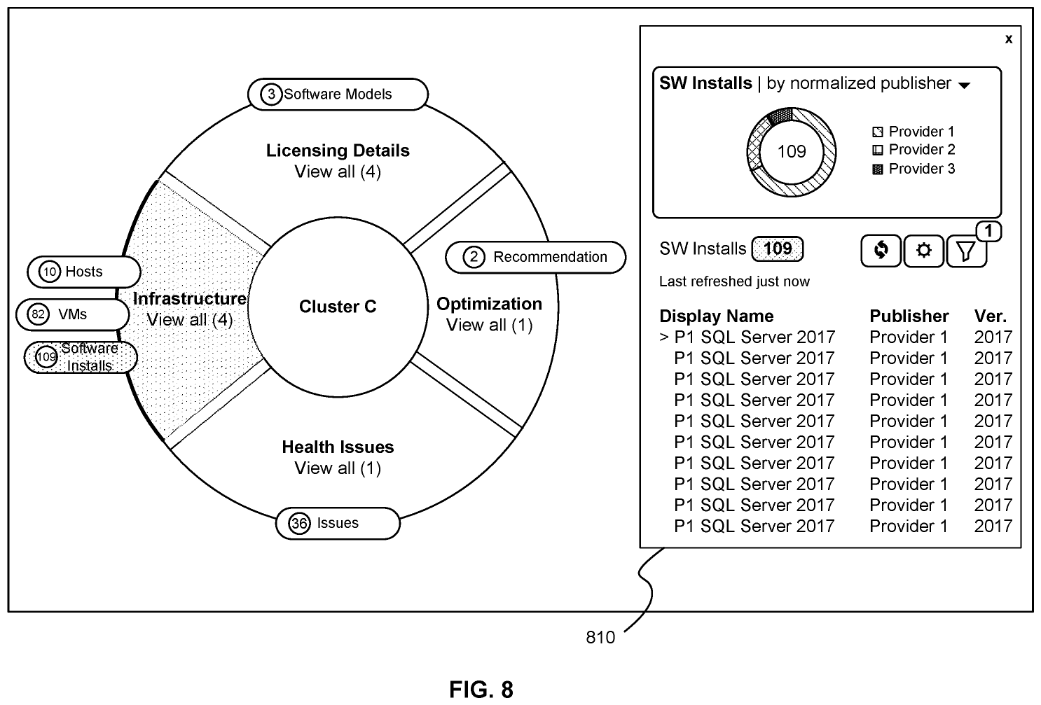

Each visual user interface element may have buttons/elements to display additional information associated with that user interface element. Selecting the various elements causes the user interface to be updated to show additional information. For example, selecting 546 causes the user interface of FIG. 6 to be displayed. Selecting 547 causes the user interface of FIG. 7 to be displayed. Selecting 548 causes the user interface of FIG. 8 to be displayed.

The information is displayed for Provider 1 (indicated by element 502), and this user interface is sometimes referred to as SAM Cluster 360° (element 504) because the information is shown in a circular visual element. Various different ways of presenting the information may be toggled via button 508. A summary of the information may be displayed in a pop-up window 516.

The optimization visual user interface element 520 includes an identification of a number of software instances associated with the computing infrastructure resource utilizations of the specific cluster exceeding a threshold.

In various embodiments, the optimization includes identification of a location within the specific cluster in which to utilize a software license, the software license being associated with the identified software license utilizations of the specific cluster. As described herein, the location may be but is not limited to a physical location, host, device, software instance, or virtual machine instance. Examples of software licensing models are further described herein, and the location where the software license is utilized may correspond to permitted licensing locations.

In various embodiments, the optimization is based at least on a reconciliation of at least one of: a publisher, a product, an edition, and a version of a software associated with the identified software license utilizations of the specific cluster. Reconciliation may be performed using existing processes such as those available from ServiceNow® to model various license usage scenarios, taking into account the logic of various software publishers or providers. Reconciliation provides a recommendation for a number of licenses for a particular cluster. The optimization may be based on a model of potential software license utilizations of the specific cluster, the potential software license utilizations of the specific cluster being based at least on a range of movement permitted for a virtual machine associated with the specific cluster. Another example of an optimization is described with respect to FIG. 3.

Potential software license utilizations may be determined using host affinity rules. A host affinity rule defines permitted destinations for a VM. Thus, to determine whether a VM can be moved from a first host to a second host, a host affinity rule may be consulted. The host affinity rules may be defined by an administrator such as a customer of the application server who is using a vendor's product.

The health issues visual user interface element 530 indicates a health issue. The health issue may be associated with the at least one of: the computing infrastructure resource utilizations of the specific cluster or the identified software license utilizations of the specific cluster. Alternatively, the health issue may be associated with the at least one of: the computing infrastructure resource utilizations of the specific cluster or the identified software license utilizations of the specific cluster. For example, health issues may be identified during discovery or be other CMDB issues. All issues associated with a particular cluster may be displayed.

FIG. 6 shows an example of a user interface for visualizing a cluster to support software asset management including host information obtained in some embodiments. Each of the components are like their counterparts in FIG. 5 unless otherwise described herein. The “hosts” button 546 indicates the number of hosts in this cluster, which is 10 hosts.

A panel 610 associated with a selected element of at least one of: the first visual user interface element or the second visual user interface element is displayed. In this example, the selected element is “hosts” button 546. Thus, the panel includes information about at least one of the hosts of the specific cluster. Information can be shown for different vendors deployed for a cluster. A host may be displayed by a production or test environment. A breakdown of the percentage of hosts in each type of environment may be visually represented such as in graph 614. For example, the hosts and their respective attributes may be displayed. For example, the VMs for a particular host may be displayed, e.g., by selecting a specific host. As another example, software installations on the host may be viewed. The panel 610 may be scrollable to shown additional columns and rows.

All VMs for the cluster may be displayed by selecting the button below 546, which causes a user interface such as the one shown in the following figure to be displayed.

FIG. 7 shows an example of a user interface for visualizing a cluster to support software asset management including virtual machine information obtained in some embodiments. Each of the components are like their counterparts in FIG. 6 unless otherwise described herein. In this example, the panel 710 includes information about cores associated with the specific cluster. A number of CPUs or CPU cores associated with specific VMs may be displayed. Information can be shown for the VMs running on a particular host along with attributes of the VMs. If a VM can move between hosts, the potential hosts can be displayed.

FIG. 8 shows an example of a user interface for visualizing a cluster to support software asset management including software installation information obtained in some embodiments. This user interface shows the software products deployed in a particular cluster. Each of the components are like their counterparts in FIG. 6 unless otherwise described herein. In this example, the panel 810 includes information about software installations of the specific cluster. This panel conveys information about deployment such as the various versions and editions of software installations.

FIGS. 5-8 show examples of infrastructure details. The following figure shows an example of licensing details that may be displayed within a unified user interface.

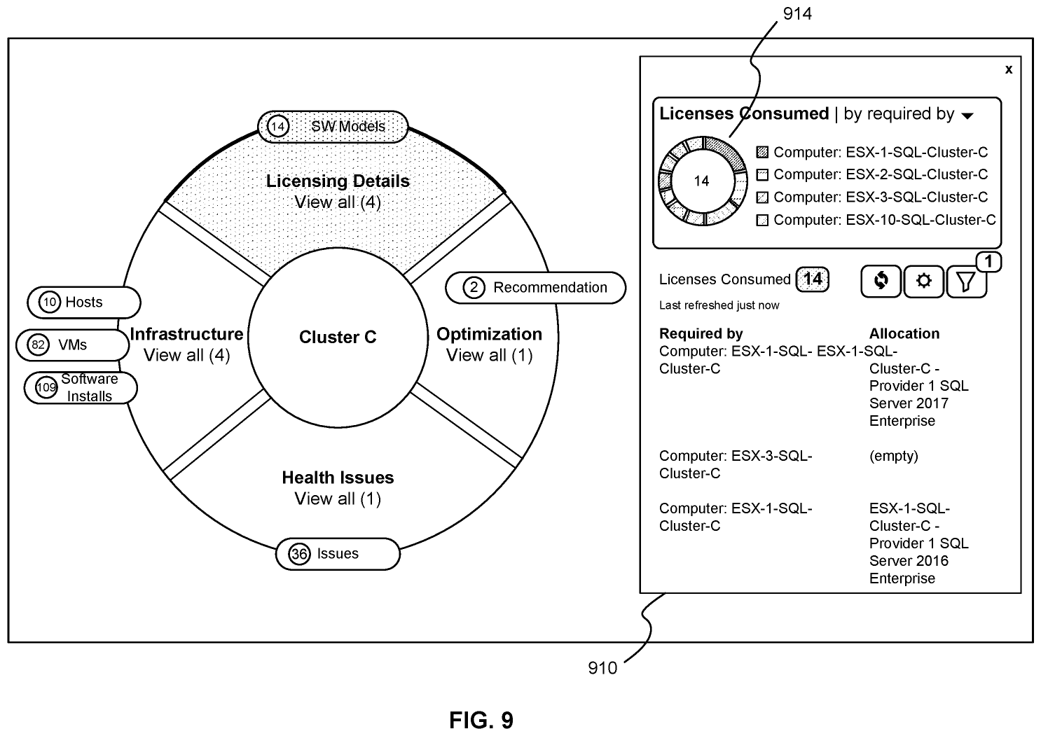

FIG. 9 shows an example of a user interface for visualizing a cluster to support software asset management including licensing information obtained in some embodiments. Each of the components are like their counterparts in FIG. 6 unless otherwise described herein. This example shows another example of licenses consumed for a software different from the one shown in the earlier figures. In this example, the panel 910 includes information about the identified software license utilizations of the specific cluster. There is a visual representation 914 of the identified software license utilizations of the specific cluster. This information may be useful (e.g., to a SAM manager) to understand entitlements related to the software, which license was actually consumed, the licensing rules of a particular software, etc. “Allocation” refers to application server specific rules that may be customer-defined. For example, a particular host or VM may be prioritized over another host or VM according to the allocation.

The disclosed unified user interface can be helpful to answer various questions regarding SAM such as:
Why does a particular SQL server consume so many licenses? (e.g., more than expected given the number of software installations)
How many VMs are running in a particular cluster?
What optimizations can be performed across a cluster?
Is the number of software installations problematic from a performance standpoint?

The disclosed unified user interface can provide specific recommendations such as:
The number of software installations in the current cluster may lead to performance degradation
Suggestion of locations (e.g., a specific layer) in which to assign a license for (cost) optimization
Suggestion to switch to a different type of license for (cost) optimization

FIG. 10 is a functional diagram illustrating a programmed computer system for visualization of clusters to support software asset management in accordance with some embodiments. As will be apparent, other computer system architectures and configurations can be used to visualize clusters to support software asset management. Computer system 1000, which includes various subsystems as described below, includes at least one microprocessor subsystem (also referred to as a processor or a central processing unit (CPU)) 1002. For example, processor 1002 can be implemented by a single-chip processor or by multiple processors. In some embodiments, processor 1002 is a general purpose digital processor that controls the operation of the computer system 1000. Using instructions retrieved from memory 1010, the processor 1002 controls the reception and manipulation of input data, and the output and display of data on output devices (e.g., display 1018). In some embodiments, processor 1002 includes and/or is used to execute/perform the process described with respect to FIG. 1.

Processor 1002 is coupled bi-directionally with memory 1010, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1002. Also as is well known in the art, primary storage typically includes basic operating instructions, program code, data and objects used by the processor 1002 to perform its functions (e.g., programmed instructions). For example, memory 1010 can include any suitable computer-readable storage media, described below, depending on whether, for example, data access needs to be bi-directional or uni-directional. For example, processor 1002 can also directly and very rapidly retrieve and store frequently needed data in a cache memory (not shown).

A removable mass storage device 1012 provides additional data storage capacity for the computer system 1000, and is coupled either bi-directionally (read/write) or uni-directionally (read only) to processor 1002. For example, storage 1012 can also include computer-readable media such as magnetic tape, flash memory, PC-CARDS, portable mass storage devices, holographic storage devices, and other storage devices. A fixed mass storage 1020 can also, for example, provide additional data storage capacity. The most common example of mass storage 1020 is a hard disk drive. Mass storages 1012, 1020 generally store additional programming instructions, data, and the like that typically are not in active use by the processor 1002. It will be appreciated that the information retained within mass storages 1012 and 1020 can be incorporated, if needed, in standard fashion as part of memory 1010 (e.g., RAM) as virtual memory.

In addition to providing processor 1002 access to storage subsystems, bus 1014 can also be used to provide access to other subsystems and devices. As shown, these can include a display monitor 1018, a network interface 1016, a keyboard 1004, and a pointing device 1006, as well as an auxiliary input/output device interface, a sound card, speakers, and other subsystems as needed. For example, the pointing device 1006 can be a mouse, stylus, track ball, or tablet, and is useful for interacting with a graphical user interface.

The network interface 1016 allows processor 1002 to be coupled to another computer, computer network, or telecommunications network using a network connection as shown. For example, through the network interface 1016, the processor 1002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1002 can be used to connect the computer system 1000 to an external network and transfer data according to standard protocols. For example, various process embodiments disclosed herein can be executed on processor 1002, or can be performed across a network such as the Internet, intranet networks, or local area networks, in conjunction with a remote processor that shares a portion of the processing. Additional mass storage devices (not shown) can also be connected to processor 1002 through network interface 1016.

An auxiliary I/O device interface (not shown) can be used in conjunction with computer system 1000. The auxiliary I/O device interface can include general and customized interfaces that allow the processor 1002 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 10 is but an example of a computer system suitable for use with the various embodiments disclosed herein. Other computer systems suitable for such use can include additional or fewer subsystems. In addition, bus 1014 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining information regarding computing infrastructure resource utilizations of hosts of a specific cluster;
identifying software license utilizations of the hosts of the specific cluster; and
providing, via a user interface, a first visual user interface element indicating an aggregation of the computing infrastructure resource utilizations of the specific cluster, and a second visual user interface element indicating an aggregation of the identified software license utilizations of the specific cluster.

2. The method of claim 1, wherein the user interface is a unified interface including the first visual user interface element and the second visual user interface element within a same view.

3. The method of claim 1, wherein obtaining the information regarding computing infrastructure resource utilizations of the hosts of the specific cluster includes performing a discovery process with respect to the hosts of the specific cluster.

4. The method of claim 1, wherein:
the identification of the software license utilizations of the hosts of the specific cluster includes an identification of a software license of the software license utilizations and a corresponding location where the software license is utilized, and
the location includes at least one of: a physical location, a host of the hosts of the specific cluster, a device associated with the specific cluster, a software instance, or a virtual machine instance.

5. The method of claim 1, further comprising providing, via the user interface, a third visual user interface element indicating an optimization associated with at least one of: the computing infrastructure resource utilizations of the specific cluster or the identified software license utilizations of the specific cluster.

6. The method of claim 5, wherein the optimization includes an identification of a number of software instances associated with the computing infrastructure resource utilizations of the specific cluster exceeding a threshold.

7. The method of claim 5, wherein:
the optimization includes identification of a location within the specific cluster in which to utilize a software license,
the software license being associated with the identified software license utilizations of the specific cluster, and
the location includes at least one of: a physical location, a host of the hosts of the specific cluster, a device associated with the specific cluster, a software instance, or a virtual machine instance.

8. The method of claim 5, wherein the optimization is based at least on a reconciliation of at least one of: a publisher, a product, an edition, and a version of a software associated with the identified software license utilizations of the specific cluster.

9. The method of claim 5, wherein the optimization is based at least on a model of potential software license utilizations of the specific cluster, the potential software license utilizations of the specific cluster being based at least on a range of movement permitted for a virtual machine associated with the specific cluster.

10. The method of claim 5, further comprising providing, via the user interface, a fourth visual user interface element indicating a health issue associated with the at least one of: the computing infrastructure resource utilizations of the specific cluster or the identified software license utilizations of the specific cluster.

11. The method of claim 1, further comprising providing, via the user interface, a third visual user interface element indicating a health issue associated with at least one of: the computing infrastructure resource utilizations of the specific cluster or the identified software license utilizations of the specific cluster.

12. The method of claim 1, wherein the first visual user interface element and the second visual user interface element are presented as respective wedges in a circular shape.

13. The method of claim 12, further comprising providing a panel associated with a selected element of at least one of: the first visual user interface element or the second visual user interface element.

14. The method of claim 13, wherein the panel includes information about at least one of the hosts of the specific cluster or cores associated with the specific cluster.

15. The method of claim 13, wherein the panel includes information about software installations of the specific cluster.

16. The method of claim 13, wherein the panel includes information about the identified software license utilizations of the specific cluster.

17. The method of claim 16, wherein the panel includes a visual representation of the identified software license utilizations of the specific cluster.

18. The method of claim 1, further comprising providing a dashboard for governance management associated with the identified software license utilizations of the specific cluster.

19. A system, comprising:
a processor configured to:
obtaining information regarding computing infrastructure resource utilizations of hosts of a specific cluster;
identifying software license utilizations of the hosts of the specific cluster; and
providing, via a user interface, a first visual user interface element indicating an aggregation of the computing infrastructure resource utilizations of the specific cluster, and a second visual user interface element indicating an aggregation of the identified software license utilizations of the specific cluster; and
a memory coupled to the processor and configured to provide the processor with instructions.

20. A computer program product embodied in a non-transitory computer readable medium and comprising computer instructions for:
obtaining information regarding computing infrastructure resource utilizations of hosts of a specific cluster;
identifying software license utilizations of the hosts of the specific cluster; and
providing, via a user interface, a first visual user interface element indicating an aggregation of the computing infrastructure resource utilizations of the specific cluster, and a second visual user interface element indicating an aggregation of the identified software license utilizations of the specific cluster.
